(19) United States
(12) Patent Application Publication
(10) Pub. No.: US 2004/0255792 A1
(43) Pub. Date: Dec. 23, 2004

(54) Cooking implement and method

(76) Inventor: James Parker, Dallas, GA (US)

Correspondence Address: GARDNER GROFF, P.C., PAPER MILL VILLAGE, BUILDING 23, 600 VILLAGE TRACE, SUITE 300, MARIETTA, GA, 30067, US

(21) Appl. No.: 10/870,614

(22) Filed: Jun. 17, 2004

Related U.S. Application Data
(60) Provisional application No. 60/479,120, filed on Jun. 17, 2003.

(51) Int. Cl. A47J 37/10

(52) U.S. Cl. 99/422

(57) ABSTRACT

A cooking implement for pressing meat or other food products while cooking them includes a plate and a handle. The plate is preferably sized and shaped to generally conform to the size and shape of a cooking surface such as a pan, skillet, or griddle. In addition, the plate is preferably made of a conductive material so that it cooks the food on its the top side.

This application claims the priority benefit of U.S. Provisional Patent Application Ser. No. 60/479,120 filed Jun. 17, 2003, the entire scope and content of which is hereby incorporated herein by reference.

### TECHNICAL FIELD

The present invention relates generally to implements for use when cooking food and, in particular, to an implement for pressing meats and other food products while they are being cooked.

### BACKGROUND OF THE INVENTION

Food products such as meats are often fried, sautéed, seared, blanched, or otherwise cooked in a pan on a stove. When cooking in this fashion, however, the meat is cooked only from the bottom side, juices and flavor are cooked out of the meat, and/or grease splatters and causes a mess. This is particularly a problem when cooking bacon, sausage, hamburgers, pork chops, chicken, streak-o-lean, and other meats.

In addition, when cooking bacon and streak-o-lean, these strips of meat tend to buckle instead of lying flat in the pan. Because of this, the meat does not cook uniformly and consistently along its length.

Accordingly, there is a need for a cooking implement that more thoroughly and uniformly cooks food products, that seals in the meat's juices and flavor, and that eliminates or reduces messes from splattering grease. It is primarily to the provision of such a cooking implement that the present invention is directed.

### SUMMARY OF THE INVENTION

The present invention includes a cooking implement for cooking food products on a cooking surface. The implement can be used for cooking a variety of different food products, but has been found to produce especially good results for bacon, streak-o-lean, and other similarly thin pieces of meat that tend to buckle when cooked. In addition, the implement is primarily designed for use with a pan, but it can be used in an oven or on a grill.

Generally described, the implement comprises a plate and a handle attached to the plate. The plate is for contacting and being supported on the food being cooked. And the handle is for picking up and handling the implement. In use, the plate compresses the food, seals in juices, and reduces any splattering from grease, etc.

In one aspect of the invention, the plate may have a shape that generally conforms to the shape of the bottom of the pan, and it may have a peripheral dimension that is the same as or slightly less than the peripheral dimension of the pan bottom. In this way, the plate can be received in the pan and supported on the food while leaving little or no gap around a peripheral edge of the plate when the food product is bacon or steak-o-lean. The typical kitchen can be provided with a set of the implements, each designed for use with a particular shape and size of pan.

In another aspect of the invention, the plate may be made of a conductive material so that the plate transfers heat to the top side of the food. In this way, the food gets cooked on its top side as well as its bottom side.

In yet another aspect of the invention, the cooking implement is preferably designed to be heavy enough that it compresses bacon or steak-o-lean to generally flat. In this way, the flattened bacon or steak-o-lean gets more thoroughly and uniformly cooked. But the cooking implement is also preferably designed to be light enough that it only slightly compresses omelets, French toast, and pancakes.

In still another aspect of the invention, the handle may include two (or another number of) extension portions and a grasping portion. Preferably, the extension portions are long enough that sufficient heat dissipates along their length so that the grasping portion does not get too hot to touch with bare hands under typical cooking conditions on a stove. In addition, the handle is preferably detachably coupled to the plate so that the handle can be removed for cleaning and compact storage. For example, the implement may include two (or another number of) clips for detachably coupling the handle to the plate.

In addition to the cooking implement, the present invention provides a method for cooking food products. The method includes the steps of providing a cooking implement comprising a plate and a handle, placing a food product on a heated cooking surface, and positioning the cooking implement on the food product so that the plate contacts and is supported on the food product. Preferably, the step of positioning the cooking implement on the food product includes positioning the plate in the pan while leaving little or no gap around a peripheral edge of the plate, and pressing down on the handle to press the food to generally flat, particularly if the food is bacon or streak-o-lean. In this way, the plate compresses the food for more thorough and uniform cooking, seals in juices, and reduces grease splattering.

Accordingly, the present invention provides a cooking implement and method for enhanced cooking of meat and other food products. In particular, the cooking implement and method can be used to cook the top side of the food. And for bacon and other food strips that tend to buckle, the cooking implement and method can be used to compress the meat slightly while cooking it. In this way, the food is more thoroughly and uniformly cooked, the juices and flavor are sealed in, and any grease splattering is significantly reduced.

The specific techniques and structures employed by the invention to improve over the drawbacks of the prior devices and accomplish the advantages described herein will become apparent from the following detailed description of the exemplary embodiments of the invention and the appended drawings and claims.

### BRIEF DESCRIPTION OF THE DRAWINGS

FIG. 1 is a perspective view of a cooking implement according to a first exemplary embodiment of the present invention, showing the implement ready for use in a pan.

FIG. 2 is a cross section view of the cooking implement of FIG. 1, showing the cooking implement in use, with its plate positioned in the pan and on a piece of meat and with its handle extending out of the pan.

FIG. 3 is a plan view of the plate of the cooking implement of FIG. 2.

FIG. 4 is a side view of the plate of the cooking implement of FIG. 3.

FIG. 5 is a plan view of the handle of the cooking implement of FIG. 2.

FIG. 6 is a side view of the handle of the cooking implement of FIG. 5.

FIG. 7 is a plan view of a plate of a cooking implement according to a second exemplary embodiment.

FIG. 8 is a side view of the plate of the cooking implement of FIG. 7.

FIG. 9 is a plan view of a handle of the cooking implement of FIG. 7.

FIG. 10 is a side view of the handle of the cooking implement of FIG. 9.

FIG. 11 is a plan view of a plate of a cooking implement according to a third exemplary embodiment.

FIG. 12 is a side view of the plate of the cooking implement of FIG. 11.

FIG. 13 is a plan view of a handle of the cooking implement of FIG. 11.

FIG. 14 is a side view of the handle of the cooking implement of FIG. 13.

FIG. 15 is a side view of a cooking implement according to a fourth exemplary embodiment, showing a plate and a handle with a knob.

FIG. 16 is a plan view of the cooking implement of FIG. 15.

FIG. 17 is a side view of a cooking implement according to a fifth exemplary embodiment, showing a plate and a handle detachably coupled to the plate by clips.

FIG. 18 is a plan view of the cooking implement of FIG. 17.

FIG. 19 is a side view of a cooking implement according to a sixth exemplary embodiment, showing a plate and a handle extending from one side of the plate and attached to the plate at only that place.

FIG. 20 is a plan view of the cooking implement of FIG. 19.

### DETAILED DESCRIPTION OF EXEMPLARY EMBODIMENTS

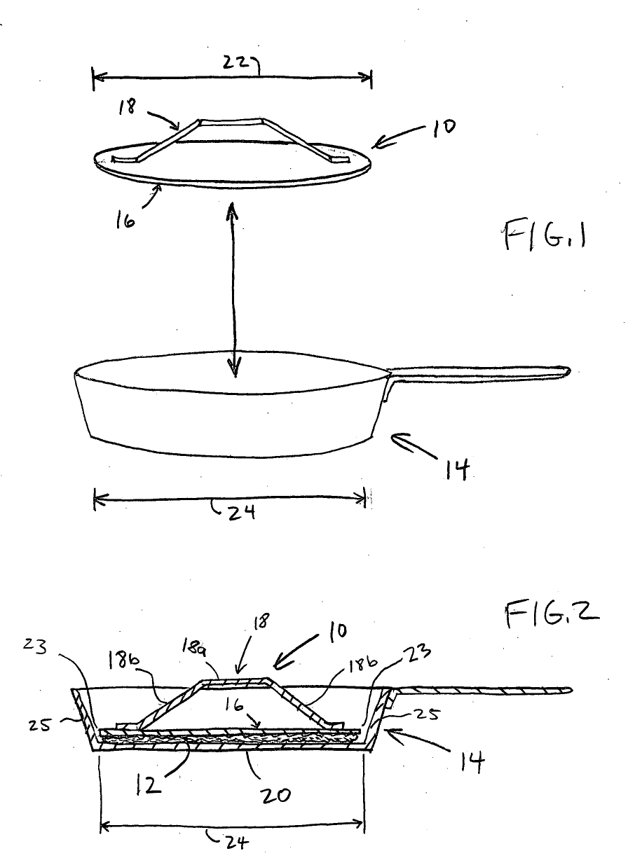

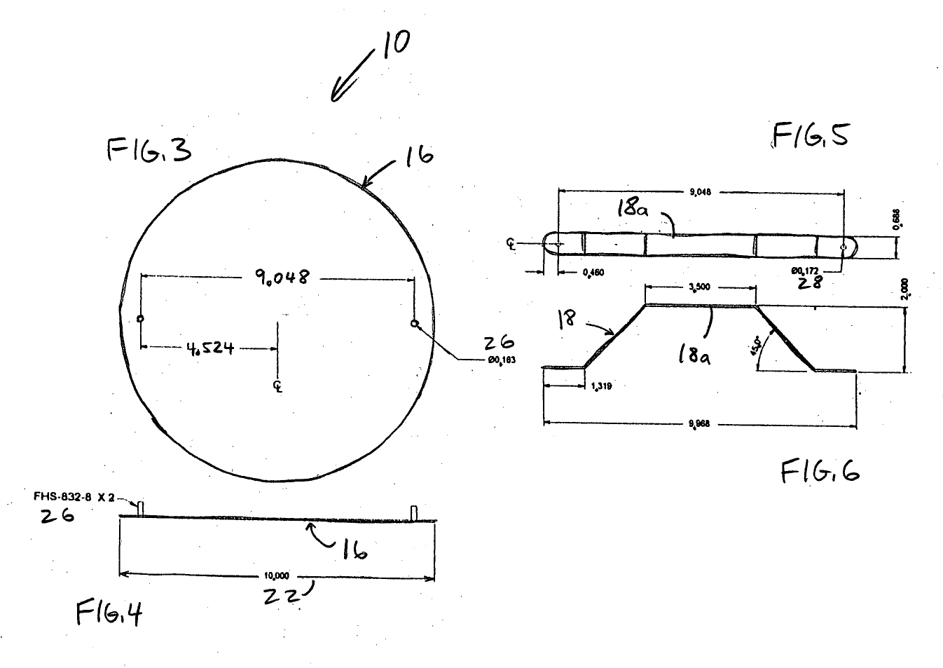

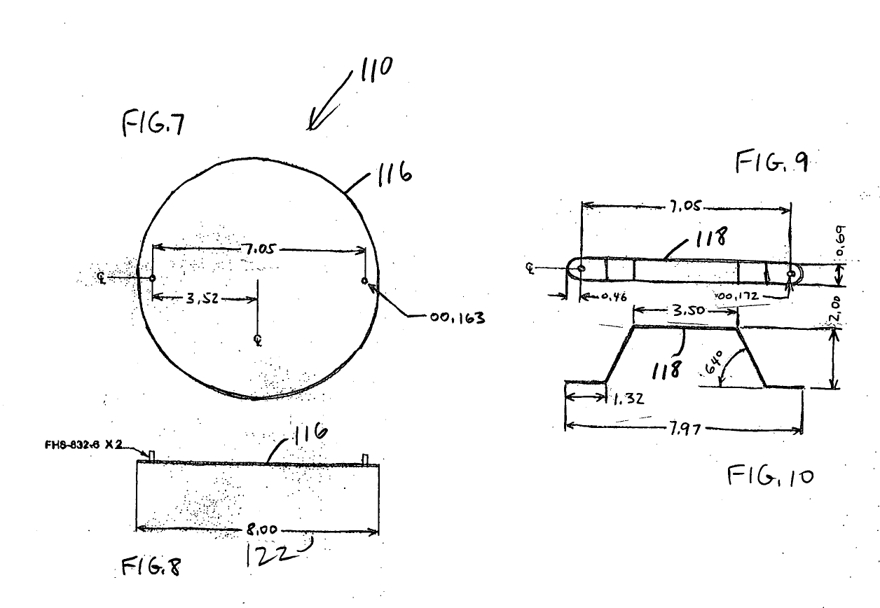

Referring to the drawing figures, FIGS. 1-6 show a cooking implement 10 according to a first exemplary embodiment of the present invention. As shown in FIGS. 1 and 2, the implement 10 is used when cooking meat 12 or other food products. For convenience, the implement 10 will be described herein in connection with cooking meat 12 in a pan 14. As used herein, the term “pan” includes skillets, griddles, pots, dishes, and similar cookware with flat cooking surfaces and upright sides. The implement 10 can be used to cook meat 12 such as bacon, streak-o-lean, sliced breakfast ham, sausage, hamburgers, pork chops, chicken, and other meat. It will be understood that the implement 10 can be used for cooking other types of food products in other ways. For example, the implement 10 can be used to cook food products such as vegetables, fruit, bread, grilled cheese and other sandwiches, French toast, pancakes, omelets, and other food products. In addition, the implement 10 can be used to cook the food products on a grill or in an oven or over an open fire. When the implement 10 is used on a covered grill or in an oven, an insulated oven mitt may be needed.

The implement 10 includes a plate 16 and a handle 18. Preferably, the plate 16 is made of a material that conducts heat well enough to help cook the meat 12 from the top side. That is, the plate material is selected with a thermal conductivity such that heat transfers from the pan 14 to the plate 16 by convectional, and from plate 12 to the top side of the meat 12 by conduction. The handle 18 is made of a material that dissipates heat well enough that a grasping portion 18a of the handle does not normally get too hot to touch with bare hands when cooking on a stove. For example, the material for the plate 16 and the handle 18 may be selected to be sixteen gauge stainless steel. When the implement 10 is made of this material, it is dishwasher-safe and should not rust. Alternatively, the plate 16 and the handle 18 may be made of other materials selected for the desired thermal conductivity and weight, and for good strength and durability.

As shown in FIGS. 1-4, the plate 16 is sized and shaped for being received in the pan 14. More particularly, the plate 16 has a shape that generally conforms to the shape of a bottom 20 of the pan 14 for providing good coverage of meat 12 placed anywhere on the bottom 20 of the pan 14. And the plate 16 has a peripheral dimension 22 that is the same as or slightly less than a peripheral dimension 24 of the pan bottom 20 (the cooking surface). With this peripheral dimension 22, the plate 16 can fit within the pan 14 and be in good contact with and supported on the meat 12 being cooked, while leaving little or no gap around its peripheral edge 23 (i.e., between the peripheral edge 23 of the plate 16 and the upright side 25 of the pan 14) when the meat is bacon, streak-o-lean, or other similarly thin pieces of food. In the embodiment shown, for example, the plate 16 has a circular shape for being received in a circular pan. And the peripheral dimension 22 of the plate 16 is a ten-inch diameter. It will be understood that other regular and irregular shapes and sizes can be used with good results.

In addition, the size of the plate 16 and the conductive material are selected so that the cooking implement 10 is heavy enough that it flattens out meat 12 such as bacon and steak-o-lean that tends to buckle when cooked. But the size of the plate 16 and the conductive material are preferably also selected so that the cooking element 10 is light-weight enough that, when resting on the food being cooked (for batter or egg dishes, after it has begun to solidify), the plate only slightly compresses foods such as omelets, French toast, and pancakes. As used herein, “only slightly” compressing means minimal compression such that the food product is not overly flattened to the point of being aesthetically unpleasing and unappetizing relative to what the food product looks like when cooked using traditional cookware. For example, in the embodiment shown the plate has a ten-inch diameter, is about one sixteenth of an inch thick, and is made of sixteen gauge stainless steel, which results in a good weight that meets these criteria.

As shown in FIGS. 1, 2, 5, and 6, the handle 18 is coupled to the plate 16. Preferably, the handle 18 is detachably coupled to the plate 16 by fasteners so that the handle can be removed from the plate and both components can be easily received in a conventional residential dishwasher for cleaning. In the typical commercial embodiment shown, for example, the handle 18 is detachably coupled to the plate 16 by screws 26 that extend through holes 28 in the handle and wing nuts (not shown) that fasten to the screws. It will be understood that other fasteners known in the art can be used to detachably couple the handle to the plate 16. Alternatively, the handle 18 may be permanently coupled to the plate 16 by permanent fasteners such as rivets, welding, or other permanent fastening members or techniques. And other handle configurations known in the art can be used with good results.

In the depicted embodiment, the handle 18 is a strip of material that has a grasping portion 18a between two extension portions 18b (see FIG. 2). The grasping portion 18a is for the user to grasp, and the extension portions 18b are coupled to the plate 16. Preferably, the extension portions 18b are long enough that sufficient heat dissipates along their length so that the grasping portion 18a doesn't get too hot to touch with bare hands under typical cooking conditions (any heat setting between “low” and “high”) on a stove. Additionally or alternatively, the handle 18 may include a section, outer coating, or extension made of rubber, hard plastic, or another thermal insulating material. And an insulated washer, strip, pad, etc. may be inserted between the plate 16 and the handle 18 to further reduce heat transferred to the grasping portion 18a.

Referring now to FIGS. 7-10, there is shown a cooking implement 110 according to a second exemplary embodiment of the present invention. The implement 110 is similar to that of the first exemplary embodiment, having a plate 116 and a handle 118. In this embodiment, however, the plate 116 has a peripheral dimension 122 that is an eight-inch diameter, for use in smaller pans.

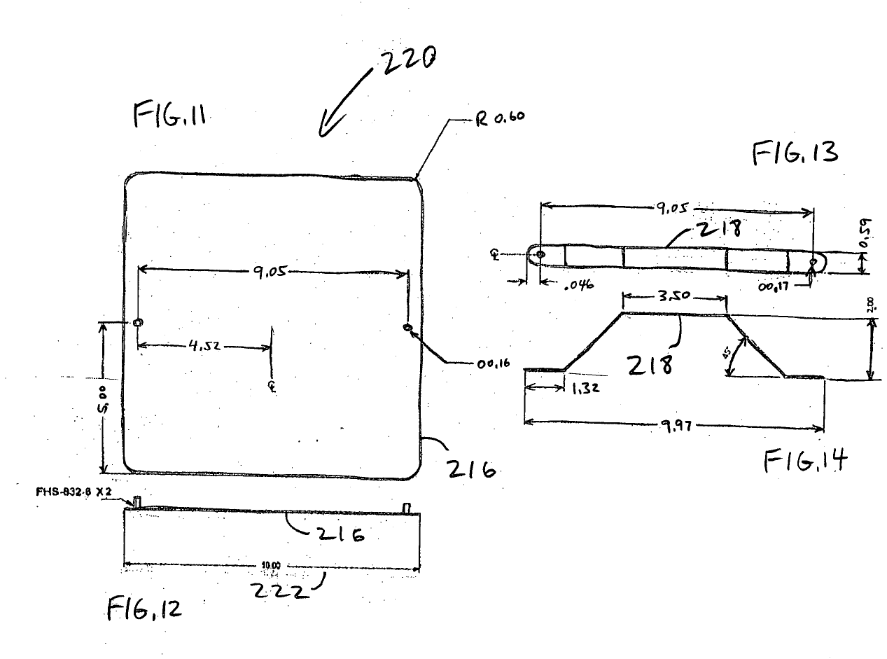

Referring now to FIGS. 11-14, there is shown a cooking implement 210 according to a third exemplary embodiment of the present invention. The implement 210 is similar to that of the first exemplary embodiment, having a plate 216 and a handle 218. In this embodiment, however, the plate 216 is square for use with square griddles, and has a peripheral dimension 222 that is a ten-inch width.

It should be noted that FIGS. 3-14 include dimensions, which are in inches. These figures depict several typical commercial embodiments of the invention, and are included for illustration purposes only. Thus, the invention is not limited to the particular dimensions shown. For example, in order to increase heat dissipation along the handle, it may be provided with a grasping portion that is longer (e.g., 3.8 in.) and spaced farther from the plate (e.g., 2.125 in.).

Referring now to FIGS. 15 and 16, there is shown a cooking implement 310 according to a fourth exemplary embodiment of the present invention. The implement 310 is similar to that of the first exemplary embodiment, having a plate 316 and a handle 318. In this embodiment, however, the handle 318 has a grasping portion provided by a knob made of, or having a layer of section made of, wood, hard plastic, or another insulating material.

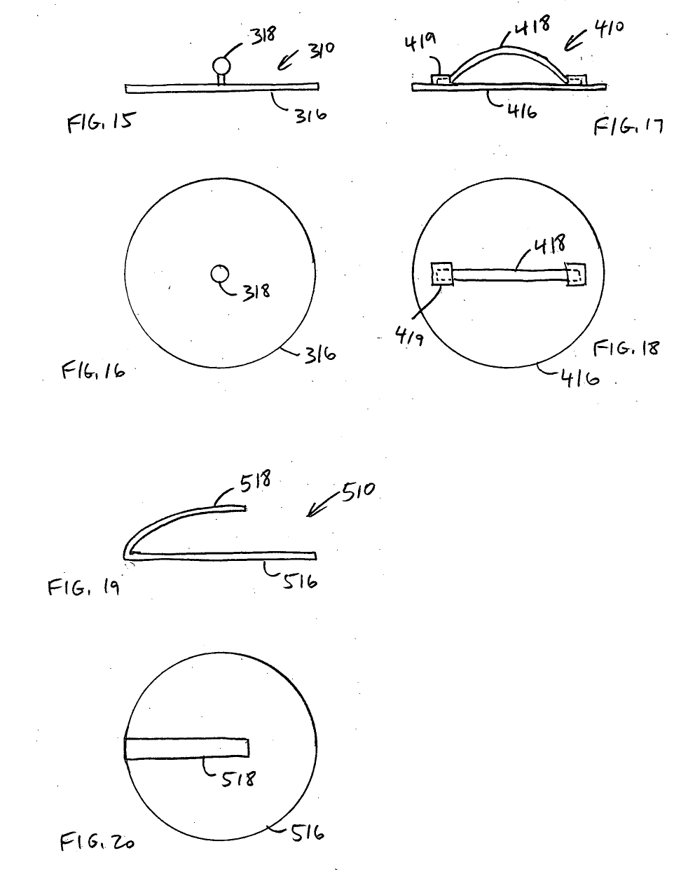

Referring now to FIGS. 17 and 18, there is shown a cooking implement 410 according to a fifth exemplary embodiment of the present invention. The implement 410 is similar to that of the first exemplary embodiment, having a plate 416 and a handle 418. In this embodiment, however, the handle 418 is detachably coupled to the plate 416 by clips 419. For example, the clips 419 may include flanges mounted to or formed on or in the plate 418, and defining opposing recesses for receiving an end of the handle 418. The handle 418 is removed by deflecting the extension portions of the handle inward, removing the ends from the opposing recesses, and releasing the handle so that it elastically returns to its normal state. The handle can be installed by reversing the process. In an alternative embodiment, the clips have side recesses for laterally removing and reinstalling the handle. And in other alternative embodiments, the handle 418 is detachably coupled to the plate 416 by another releasable locking mechanism such as a snap-fit connection, a latch, and/or deflectable tabs received in a slot.

Referring now to FIGS. 19 and 20, there is shown a cooking implement 510 according to a sixth exemplary embodiment of the present invention. The implement 510 is similar to that of the first exemplary embodiment, having a plate 516 and a handle 518. In this embodiment, however, the handle 518 is integrally formed with the plate 516 as a single piece that extends from and bends at least back part of the way over the plate 418. As such, the handle 518 has one grasping portion and one extension portion. Alternatively, the handle 518 can be provided as a separate piece, with at least the grasping portion being insulated.

In alternative embodiments, the plate has ridges, bumps, patterns of intersecting ridges or bumps, or other regular or irregular protrusions on its bottom side. These protrusions may be adapted for increasing the heated surface area on the top side of the meat for enhanced cooking, burning into the meat grill marks or other patterns, and/or gripping a non-flat food product such as chicken. In addition, the protrusions may include sharp spikes for tenderizing the meat before and/or during cooking.

In another alternative embodiment, the plate has holes in it for preventing too much pressure from building up underneath it for safety purposes. In yet another alternative embodiment, the plate and the handle are made of a material that is microwave-safe for use in conventional microwave ovens. In still another alternative embodiment, the plate has a non-stick coating such as TEFLON or the like. And in another alternative embodiment, the plate has a peripheral edge that is at least slightly tapered (so that the top surface is larger than the bottom) at an angle selected for use with pans and skillets that have sides that are angled (see, for example, the pan of FIG. 2).

In still other alternative embodiments, the cooking implement is adapted for use on outdoor grills. In these embodiments, the plate may be round for use with round grills, rectangular for use with rectangular grills, or in another regular or irregular shape if desired. The plate may be sized to cover substantially all of the grill cooking surface area. Alternatively, the plate may be sized to cover half or another portion of the grill cooking surface area. For example, for use on a rectangular grill, the plate may include two rectangular plate sections hinged together, each plate being about one-half the total grill cooking surface area, with a longitudinal handle (similar to the handle on the pan shown in FIGS. 1 and 2) extending laterally from the plate. In this way, the plates can be unfolded for covering meat on placed on the entire grill cooking surface area, or folded for covering meat placed on only half.

Having described various embodiments of the cooking implement of the present invention, a method for cooking food products will now be described. The method can be used to cook meat and other food products to enhance their taste and flavor. Generally described, the method includes the steps of providing a cooking implement comprising a plate and a handle, placing a food product on a heated cooking surface, and positioning the cooking implement on the food product so that the plate contacts and is supported on the food product. In this way, the plate compresses the food product, seals in juices, and reduces any splattering.

Preferably, the cooking surface is a pan, and the step of positioning the cooking implement on the food product further comprises positioning the plate in the pan and leaving little or no gap around a peripheral edge of the plate. If the food product is bacon or streak-o-lean, the method may include pressing down on the handle to press the bacon or streak-o-lean to generally flat. If the food product is an omelet, French toast, and a pancake, the method may include resting the plate on the food product so that the cooking implement only slightly compresses the food product.

Accordingly, the present invention provides a number of advantages over traditional cooking implements and methods. In particular, the invention provides cooking implements and methods for compressing food (at least slightly) while cooking it, thereby providing the advantage of more thoroughly and uniformly cooking bacon and other food strips that tend to buckle during cooking. In addition, the invention provides cooking implements and methods for cooking the top side of food on a cooking surface such as a pan, skillet, or griddle, thereby providing the advantage of sealing in juices and flavor, significantly reducing any grease splattering, and more thoroughly, uniformly, and quickly cooking the food.

It is to be understood that this invention is not limited to the specific devices, methods, conditions, and/or parameters described and/or shown herein, and that the terminology used herein is for the purpose of describing particular embodiments by way of example only. Thus, the terminology is intended to be broadly construed and is not intended to be unnecessarily limiting of the claimed invention. In addition, as used in the specification and the appended claims, the singular forms “a,” “an,” and “the” include the plural, plural forms include the singular, and reference to a particular numerical value includes at least that particular value, unless the context clearly dictates otherwise. Furthermore, any methods described herein are not intended to be limited to the sequence of steps described but can be carried out in other sequences, unless expressly stated otherwise herein.

While certain embodiments are described above with particularity, these should not be construed as limitations on the scope of the invention. It should be understood, therefore, that the foregoing relates only to exemplary embodiments of the present invention, and that numerous changes may be made therein without departing from the spirit and scope of the invention as defined by the following claims.

What is claimed is:

1. A cooking implement for cooking food products on a cooking surface, comprising:
a plate adapted for contacting and being supported on the food product being cooked; and
a handle coupled to the plate,
wherein the plate compresses the food product, seals juices in the food product, and reduces any splattering.

2. The cooking implement of claim 1, wherein the cooking surface is a pan, and wherein plate has a shape that generally conforms to the shape of a bottom of the pan and has a peripheral dimension that is the same as or slightly less than a peripheral dimension of the pan bottom so that the plate can be received in the pan.

3. The cooking implement of claim 2, wherein the plate is sized and shaped so that it can be received in the pan and supported on the food product while leaving little or no gap around a peripheral edge of the plate when the food product is bacon or steak-o-lean.

4. The cooking implement of claim 1, wherein the plate is made of a conductive material so that the plate transfers heat to the top side of the food product for cooking the top side of the food product.

5. The cooking implement of claim 4, wherein the size of the plate and the conductive material are selected so that the cooking implement is heavy enough that it compresses the food product to generally flat when the food product is bacon or steak-o-lean.

6. The cooking implement of claim 5, wherein the size of the plate and the conductive material are selected so that the cooking implement is light-weight enough that it only slightly compresses the food product when the food product is selected from the group consisting of omelets, French toast, and pancakes.

7. The cooking implement of claim 1, wherein the handle includes at least one extension portion extending from the plate and a grasping portion extending from the extension portion.

8. The cooking implement of claim 7, wherein the extension portion is long enough that sufficient heat dissipates along its length so that the grasping portion does not get too hot to touch with bare hands under typical cooking conditions on a stove.

9. The cooking implement of claim 1, wherein the handle is detachably coupled to the plate so that the handle can be removed for cleaning and compact storage.

10. A cooking implement for cooking food products in a pan, comprising:
a plate sized and shaped for being received in the pan while contacting and being supported on the food product being cooked, wherein the plate has a shape that generally conforms to the shape of a bottom of the pan and has a peripheral dimension that is the same as or slightly less than a peripheral dimension of the pan bottom so that the plate can be received in the pan and supported on the food product while leaving little or no gap around a peripheral edge of the plate when the food product is bacon or steak-o-lean, wherein the plate is made of a conductive material so that the plate transfers heat to the top side of the food product, wherein the size of the plate and the conductive material are selected so that the cooking implement is heavy enough that it compresses the food product to generally flat when the food product is bacon or steak-o-lean, wherein the size of the plate and the conductive material are selected so that the cooking implement is light-weight enough that it only slightly compresses the food product when the food product is selected from the group consisting of omelets, French toast, and pancakes; and
a handle coupled to the plate, wherein the handle includes at least one extension portion extending from the plate and a grasping portion extending form the extension portion, wherein the extension portion is long enough that sufficient heat dissipates along its length so that the grasping portion does not get too hot to touch with bare hands under typical cooking conditions on a stove,
wherein the plate cooks the top side of the food product, compresses the food product, seals juices in the food product, and reduces any splattering.

11. The cooking implement of claim 10, wherein the handle is detachably coupled to the plate so that the handle can be removed for cleaning and compact storage.

12. The cooking implement of claim 11, further comprising at least one clip for detachably coupling the handle to the plate.

13. The cooking implement of claim 10, wherein either the pan bottom is circular with an eight inch diameter and the plate is circular with an eight inch diameter, the pan bottom is circular with a ten inch diameter and the plate is circular with a ten inch diameter, the pan bottom is square with an eight inch width and the plate is square with an eight inch width, or the pan bottom is square with a ten inch width and the plate is square with a ten inch width.

14. A method of cooking a food product, comprising:
providing a cooking implement comprising a plate and a handle coupled thereto;
placing a food product on a heated cooking surface; and
positioning the cooking implement on the food product so that the plate contacts and is supported on the food product.
wherein the plate compresses the food product, seals in juices, and reduces any splattering.

15. The method of claim 14, wherein the plate has a shape that generally conforms to a shape of the cooking surface and has a peripheral dimension that is the same as or slightly less than a peripheral dimension of the cooking surface.

16. The method of claim 15, wherein the cooking surface is a pan and the step of positioning the cooking implement on the food product further comprises positioning the plate in the pan and leaving little or no gap around a peripheral edge of the plate.

17. The method of claim 16, wherein the plate is made of a conductive material so that the plate transfers heat to the top side of the food product for cooking the top side of the food product.

18. The method of claim 14, wherein the plate is made of a conductive material so that the plate transfers heat to the top side of the food product for cooking the top side of the food product.

19. The method of claim 14, wherein the food product is bacon or streak-o-lean, and further comprising pressing down on the handle to press the bacon or streak-o-lean to generally flat.

20. The method of claim 14, wherein the food product is selected from the group consisting of omelets, French toast, and pancakes, and wherein the step of positioning the cooking implement on the food product comprises resting the plate on the food product so that the cooking implement only slightly compresses the food product.
